(19) United States
(12) Patent Application Publication
(10) Pub. No.: US 2015/0145678 A1
(43) Pub. Date: May 28, 2015

(54) Computer Network for Monitoring and Controlling Storage Facilities Comprising a Load State Device and a User Detection Device

(71) Applicants: Richard Dillon, Salzburg (AT); Philipp Herzog, Hallwang (AT); Werner Wolf, Aflenz/Kurort (AT)

(72) Inventors: Richard Dillon, Salzburg (AT); Philipp Herzog, Hallwang (AT); Werner Wolf, Aflenz/Kurort (AT)

(73) Assignee: Red Bull GmbH, Fuschl am See (AT)

(21) Appl. No.: 14/389,372

(22) PCT Filed: Mar. 29, 2012
(86) PCT No.: PCT/EP2012/001386

§ 371 Date: Jan. 20, 2015

(51) Int. Cl. G07F 9/02; G07F 9/10; G01G 19/52; G08B 21/22; G07F 11/00

(52) U.S. Cl. CPC G07F 9/02; G08B 21/22; G07F 11/002; G01G 19/52; G07F 9/105
USPC 340/568.1

(57) ABSTRACT

The present disclosure relates to a computer network comprising a storage facility, a data processing device, a data transmission device, and a server in operative connection with the storage facility. The storage facility comprises a load state detection device and a user detection device. The user detection device is configured to record a time period of at least one user in front of and/or in the vicinity of the storage facility. The load state detection device is configured to detect a removal of at least one article from the storage facility and/or loading of the storage facility with at least one article. Data acquired by the user detection device and/or the load state detection device of the storage facility can be transmitted to the server and/or can be retrieved from the server. The present disclosure also relates to a method for operating such a computer network.

### BACKGROUND

The present disclosure relates to a computer network, comprising at least one storage facility having a data processing device and a data transmission device, and at least one server that is in, or can be brought into, operative connection with the at least one storage facility, and to a method for detecting a user of such a storage facility by means of the user detection device.

### SUMMARY AND INITIAL DESCRIPTION

Computer networks have long been known in the state of the art. In such networks, one or several clients, for example, computers, mobile phones or the like, is/are in operative connection with a server. It is also known to operate home appliances, such as intelligent refrigerators, washing machines, cooking appliances, television sets, storage facilities, or the like, as clients in a network.

Storage facilities are known in the state of the art in the form of shelves, refrigerators, cupboards and the like, and storage facilities are used both in private households and in shops, for example, to store articles and present them for sale.

A special type of storage facilities are refrigeration appliances. Refrigeration appliances or refrigerators are known in the state of the art in various embodiments. In addition to classic refrigerators for domestic use, chest freezers, refrigerated display cabinets, minibars and the like are known, for example, that can either be closed by means of a door or are open and will hereinafter all be referred to as refrigeration appliances.

For example, from DE 10 2007 032 052 A1 a device for regulating the power consumption of an electrical appliance is known, wherein information provided by the electrical appliance, for example, by temperature measurement devices of a refrigerator, can be sent to a control device.

JP 2006 345 144 A describes a monitoring device for appliances that comprises at least one sensor for detecting that the appliance is opened or closed, a vibration, a sound and further data, wherein the monitoring device can transmit data of the appliance to other appliances by means of a data transmission device.

Detection systems for detecting a load state of a storage facility are also known in the state of the art. From WO 2005/015510 A1, a detection device having a sensor arrangement is known that may, for example, comprise piezoelectric weight sensors, a digital image recording system, infrared switches and/or laser sources having digital detectors for detecting a load state of a refrigeration appliance.

WO 2007/128572 describes a system for monitoring a storage of articles, wherein the system comprises a sensor for monitoring the opening or closing of a door and at least one weight sensor, wherein the system comprises a plurality of containers and each container is in operative connection with a weight sensor, and wherein the weight of a container is measured at a predefined time after the door of the container is closed.

From DE 20 2008 015 892 U1, a container having an RFID sensor for detecting an article provided with an RFID chip is known, wherein the container detects that an article is removed from or placed in the container, and wherein a weighing apparatus additionally measures the weight difference caused by removing an article from or placing an article in the container.

DE 10 2005 054 333 A1 discloses a refrigeration appliance having a plurality of storage places for articles to be stored in a storage compartment as well as a detection device for detecting the load state of a storage compartment, wherein the detection device has at least one separate sensor for detecting the state of occupation of each of the storage places in the storage compartment. Each of said sensors comprises a capacitor that is arranged such that a change in the state of occupation of the storage place associated with the sensor causes the capacity of the capacitor to change.

From DE 10 2005 052 952 A1, a refrigeration unit having a goods compartment for industrially manufactured refrigerated products is known, wherein the refrigeration unit comprises a load cell that is arranged below the refrigeration unit and has a strain gauge for measuring the weight of the refrigeration unit.

From EP 1 152 315 A2, a device and a method for monitoring and controlling a temperature of a refrigeration appliance are known, wherein the system comprises a temperature sensor and information of the refrigeration appliance is transmitted to a data processing device by means of a wireless data transmission device.

In general, it is known in the state of the art to determine the load state of a storage facility of a refrigeration unit by measuring its weight. However, in the state of the art the load state can only be determined if the storage facility is loaded with one particular type of article, and no differentiation can be made between individual batch sizes or container sizes. It can only be determined that a particular amount of one type of article is removed from the storage facility or placed in the storage facility.

According to the state of the art, complex load state detection devices or individual, additional identifications of the articles and special evaluating devices are required to precisely identify the articles that are removed, placed and/or stored. In the state of the art, an individual load state detection device is provided for each article or each group of articles in order to determine the load state of a storage facility. As an alternative of the state of the art, the articles themselves are provided with an identification, for example, an RFID chip that can be detected by a special evaluating device in order to determine the load state of a storage facility.

Also, rudimentary user detection devices are known in the state of the art that allow to detect whether a user removes an article from a storage facility and/or places an article in the storage facility.

However, the computer networks known from the state of the art have the drawback that it is not possible to precisely evaluate a user behavior and a load state of the appliances, in particular, the storage facilities, of the computer network, thus not allowing to optimize supply chains for delivery to the storage facilities.

The object of the present disclosure is therefore to eliminate the drawbacks of the state of the art. In particular, it is intended to provide a computer network that allows to precisely evaluate devices of the appliances, in particular storage facilities, connected to the network, as well as to optimize a supply chain of the appliances and to monitor how users behave when using the appliances.

This objective is achieved due to the fact that at least one of the storage facilities comprises a load state detection device and/or a user detection device, wherein the user detection device is designed and configured to detect a time period of at least one user in front of and/or adjacent to the at least one storage facility and the load state detection device is designed and configured to detect that at least one article is removed from and/or loaded into the at least one storage facility, in particular by the at least one user, wherein the acquired data of the user detection device and/or the load state detection device of the at least one storage facility can be sent to the server and/or can be retrieved from the server.

A network of storage facilities according to the present disclosure can allow to optimize supply chains of products for the storage facilities. In this context, it can advantageously be detected at which time and in which place products are removed from one of the storage facilities or products are loaded into the storage facilities. This allows to optimize the necessary logistics processes. In addition, it can be detected in which places there is a higher demand for particular products, and this information can be used for future planning of the supply processes.

In this context, it is preferred that the server is in operative connection with at least one input device and/or at least one output device, preferably a display device, in particular at least one mobile terminal, preferably a mobile phone.

Also, the server may be designed and configured to automatically retrieve data from the at least one storage facility, and/or the at least one storage facility may be designed and configured to automatically send data to the server, preferably at intervals, in particular regular intervals, wherein at least the one storage facility is designed and configured to send data relating to at least one storage facility parameter and/or from at least one user detection device, at least one load state detection device, at least one temperature measurement device, at least one operating state detection device, at least one evaluating device and/or at least one position detection device to the server and/or said data can be retrieved from the server.

In this context, it may be preferred that the server is designed and configured to sort and/or store the data in accordance with an installation site, a country, a customer group, a dealer, a dealer group and/or an identification number of the storage facility and in particular to display the data on an output device.

Also, it may be preferred that the user detection device of at least one of the storage facilities is designed and configured to detect a time period from a start of operation, restart of operation, a previous loading of and/or previous removal from the storage facilities until the next time when at least one article is removed from and/or loaded into the storage facility by the at least one user and/or operation stops, and/or to detect a time period of at least one user in front of the storage facility without removal from and/or loading of the storage facility, wherein a removal from and/or loading of the storage facility can be detected and/or is detected by the load state detection device.

In this context, it may be advantageous that the user detection device of at least one of the storage facilities comprises at least one motion detector, at least one infrared sensor and/or at least one radar module.

In this context, the user detection device of at least one of the storage facilities may also be designed and configured to scan an area in front of and/or adjacent to a front side of the storage facility, preferably an area of 180°, in particular in front of a reach-in area for removing articles from and/or loading articles into the storage facility.

An integration of a user detection device according to the present disclosure into a storage facility has in particular the advantage that the behavior of a user can be precisely detected. This is particularly advantageous as it allows to determine at which times articles are removed from the storage facility. Based on this data, it can then, for example, be determined according to the present disclosure on which days of the week and at which times more products and which types of products are removed in order to optimize restocking of the storage facility based on a load state of the storage facility. A user detection device according to the present disclosure can thus serve to optimize the supply chain of the storage facility with products, thus ensuring that the user detection device is sufficiently loaded at all times.

Also, the user detection device of at least one of the storage facilities may be arranged in the upper half, preferably on the front side, of the storage facility, in particular in a cover area, preferably above the reach-in area of the storage facility.

Also, it is preferred that data of the user detection device can be retrieved from an external server and/or sent to the external server, in particular in real time.

In this context, it may be preferred that the load state detection device of at least one of the storage facilities comprises a weighing apparatus and an evaluating device, wherein the weighing apparatus is designed and configured to detect measured values representative of a weight of the storage facility and the evaluating device is designed and configured to determine the weight of the storage facility based on the measured values of the weighing apparatus, wherein the weight of the storage facility is determined when the measured values of the weighing apparatus are not affected by devices of the storage facility and/or if the evaluating device is designed and configured to compensate for effects of the devices of the storage facility on the measuring device, in particular by means of statistical algorithms.

This has in particular the advantage that it is possible to precisely measure the weight of the storage facility and hence to determine a load state of the storage facility with different products. To be able to determine the load state of a storage facility with at least two different products, very precise measured values of the weight of the storage facility are required. However, devices of the storage facility may affect the weighing apparatus. For example, the vibrations of a compressor of a refrigerator affect the result of the weight measurement. It is thus advantageous for determining the load state of a storage facility that the measured values of the weighing apparatus are not affected by devices of the storage facility.

Also, the weighing apparatus may comprise a weighing scale, in particular a mechanical, electronic, and/or electromechanical weighing scale.

In this context, it may be preferred that the evaluating device is designed in the form or as part of a data processing unit, in particular a computer.

Also, the weighing apparatus may be designed and configured to detect the weight of the storage facility within a weighing range from 0 kg to 200 kg with a measurement accuracy in a range from one nanogram to one gram, particularly preferred in a range from one nanogram to one microgram.

According to the present disclosure, it may also be preferred that the weighing apparatus comprises at least one load cell, preferably four load cells, wherein each of the load cells preferably comprises at least one strain gauge, in particular four strain gauges, that are arranged in the form of a bridge circuit, preferably a Wheatstone bridge.

Also, the load cells may be arranged below the storage facility, preferably in the area of feet of the storage facility, between the feet of the storage facility and the storage facility and/or underneath the feet of the storage facility.

In this context, it may be preferred that it is possible to determine a load state of the storage facility with articles, or such a load state is determined, based on the weight of the storage facility, wherein, based on a change in weight of the storage facility, it can be determined or is determined, in particular, that an article is removed from the storage facility and/or an article is loaded into the storage facility.

According to the present disclosure, it may also be preferred that at least one memory is comprised that is designed and configured to store the time when at least one article is removed from and/or loaded into the storage facility, to store the number of articles that are removed during a removal and/or the number of articles placed in the storage facility when it is loaded.

In this context, it may be preferred that at least one of the storage facilities is designed and configured to store at least one article in the form of a food item, in particular a beverage, preferably a beverage can and/or a bottle.

Also, at least one of the storage facilities may comprise a computer and/or a memory, wherein the evaluating device and the data transmission device are preferably designed as one unit.

According to the present disclosure, it may also be preferred that at least one of the storage facilities comprises a data transmission device for transmitting data via a wire-based or wireless computer network and/or using a mobile communication standard, preferably a GSM and/or UMTS standard.

In this context, it may be preferred that the server is in operative connection with at least one further facility, in particular a further storage facility, a home appliance, such as a cooking appliance, a computer, a mobile phone, and/or a tablet computer.

Also, the server may be designed and configured to display and/or provide data from at least one of the storage facilities on a display device, in particular automatically, preferably by means of an e-mail, a push message, an SMS, and/or an MMS.

According to the present disclosure, it may also be preferred that at least one of the storage facilities comprises an input device, in particular a keyboard, a touch screen and/or a mouse, and/or that the storage facility comprises a device for receiving data, in particular for receiving data from an external server, and/or that the storage facility comprises a display device, in particular a display.

According to the present disclosure, it may also be preferred that at least one of the storage facilities comprises a position detection device, in particular a GPS receiver and/or a device for cell site location tracking.

Also, the position detection device may be designed and configured to detect a change of an actual position of the storage facility and preferably to transmit the actual position of the storage facility to the server.

In this context, it may be preferred that the position detection device is designed and configured to compare the actual position of the storage facility with a predefined desired position, and that in particular a difference between the actual position and the desired position can be displayed or is displayed on the display device of the storage facility, and/or that an e-mail, a push message, an SMS, and/or an MMS can be sent from the storage facility and/or the server to at least one data processing device and/or at least one mobile terminal.

Also, a desired position of the storage facility may be stored in the memory of the storage facility, and preferably it may be possible that the desired position is defined and/or changed by a user, in particular by means of the input device of the storage facility and/or of the server.

According to the present disclosure, it may also be preferred that at least one of the storage facilities comprises an operating state detection device for detecting an operating state of the storage facility, wherein the operating state detection device is preferably designed and configured to detect whether the storage facility is switched on or switched off, maintenance work is taking place or due to take place and/or the storage facility is malfunctioning or at fault.

In this context, it may be preferred that the operating state of the storage facility can be displayed on the storage facility by means of the display device and/or can be retrieved from the server and/or can be sent to the server, in particular in real time.

Also, according to the present disclosure a desired operating state may be stored in a memory, and preferably it may be possible that the desired operating state is defined and/or changed by a user, preferably in accordance with a date and/or a time of day, in particular by means of an input device of the storage facility.

According to the present disclosure, it may also be preferred that the data processing device of at least one of the storage facilities is designed and configured to compare the actual operating state with a predefined desired operating state, and that in particular a difference between the actual operating state and the desired operating state can be displayed or is displayed on the display device of the storage facility, and/or that an e-mail, a push message, an SMS, and/or an MMS can be sent to at least one data processing device and/or at least one mobile terminal.

Also, it may be possible to transmit the difference between the actual operating state and the desired operating state to the server, and preferably it may be possible to display the server, or the server may be displayed, by means of a display device, and/or it may be possible to send an e-mail, a push message, an SMS, and/or an MMS to at least one data processing device and/or at least one mobile terminal.

In this context, it may be preferred that at least one of the storage facilities comprises a temperature measurement device, wherein the temperature measurement device is designed and configured to detect the temperature at least in an area of the storage facility, and that the storage facility preferably comprises at least two temperature measurement devices, wherein at least one first temperature measurement device is designed and configured to detect at least one first temperature in a first area of the storage facility and at least one second temperature measurement device is designed and configured to detect at least one second temperature in a second area of the storage facility.

Also, it may be possible to display at least one temperature that has been measured, or said temperature may be displayed, by means of the display device of the storage facility, and/or it may be possible to retrieve said temperature from the server and/or to send said temperature to the server, in particular in real time, and preferably the at least one temperature measured may be stored in the memory continuously or at intervals, preferably regular intervals.

According to the present disclosure, it may also be preferred that reference values of the weight of at least one product, in particular of a plurality of products, are stored in the memory of at least one of the storage facilities.

In this context, it may be preferred that at least one of the storage facilities comprises at least one storage facility parameter representative of an installation site, a country, a customer group, a dealer, a dealer group and/or an identification number.

Also, it may be possible to send data relating to the storage facility parameter and/or from the user detection device, the at least one temperature measurement device, the operating state detection device, the user detection device and/or the position detection device to the server, to retrieve said data from the server and/or to display and/or store said data in accordance with a day, a time of day, a week, a year, an installation site, a customer, a country, a town/city, and/or the like continuously and/or at intervals, in particular regular intervals, in particular intervals of 30 minutes and/or 60 minutes.

According to the present disclosure, it may also be preferred that the user detection device of at least one of the storage facilities is designed and configured to detect at which time and/or on which date a user is detected by the user detection device, and that preferably the time and/or the date is stored, preferably in a memory of a data processing device, in particular a data processing device of the server.

Also, one of the storage facilities may be designed in the form of a refrigeration appliance, in particular a refrigerator, wherein the refrigeration appliance comprises a refrigeration device and preferably an operating time detection device is comprised that is designed and configured to detect and/or store an operating time of the refrigeration device, and it may in particular be possible to send the operating time that has been detected from the device to the server and/or to retrieve said operating time from the server, wherein in particular the weight of the refrigeration appliance is determined when a refrigeration device of the refrigeration appliance is not operating, and/or the refrigeration appliance may comprise a decoupling device, wherein the decoupling device is designed and configured to mechanically decouple the weighing apparatus from the refrigeration device, so that in particular vibrations of the refrigeration device will not affect the weighing apparatus.

In this context, it may be preferred that the refrigeration appliance is designed in the form of a compressor refrigerator, an absorption refrigerator and/or a thermoelectric refrigerator.

Also, the refrigerator may preferably comprise at least one refrigeration device in the form of a compressor, wherein in particular no data of the weighing apparatus is detected and/or evaluated by the evaluating device when the compressor is active, and/or an analogue and/or digital filter is comprised, wherein the filter is designed and configured to filter effects of the compressor on the load state detection device.

According to the present disclosure, it may also be preferred that the storage facility comprises a holding device for food items, in particular beverages, preferably beverage cans and/or bottles.

Also, at least one of the storage facilities may have an open storage area, in particular an open refrigerated area, and in particular no door for closing the refrigerated area.

Finally, at least one of the storage facilities may comprise a temperature measurement device, wherein the temperature measurement device is designed and configured to detect the temperature at least in an area of the storage facility, and the storage facility may preferably comprise at least two temperature measurement devices, wherein at least one first temperature measurement device is designed and configured to detect at least one first temperature in a first area of the storage facility and at least one second temperature measurement device is designed and configured to detect at least one second temperature in a second area of the storage facility.

Also, the present disclosure provides a method for operating a computer network according to the present disclosure, comprising at least one storage facility having a data processing device and a data transmission device, and at least one server that is in, or can be brought into, operative connection with the at least one storage facility, wherein at least one of the storage facilities provides a load state detection device and a user detection device, and wherein a time period of at least one user in front of the at least one storage facility is detected by the user detection device and the load state detection device detects that at least one article is removed from and/or loaded into the at least one storage facility by the at least one user, and wherein information of the user detection device and/or the load state detection device of the at least one storage facility is sent to the server and/or retrieved from the server.

Also, according to the present disclosure the server may be in operative connection with at least one input device and/or at least one output device, preferably a display device, in particular at least one mobile terminal, preferably a mobile phone.

Also, the server may retrieve data from the at least one storage facility, in particular automatically, and/or data may be automatically sent from the at least one storage facility to the server, preferably at intervals, in particular regular intervals, wherein the at least one storage facility sends data relating to at least one storage facility parameter and/or from at least one user detection device, at least one load state detection device, at least one temperature measurement device, at least one operating state detection device, at least one evaluating device and/or at least one position detection device to the server and/or retrieves said data from the server.

In this context, the server may sort and/or store the data in accordance with an installation site, a country, a customer group, a dealer, a dealer group and/or an identification number of the storage facility and in particular displays said data on an output device.

Also, it may be preferred that a time period from a start of operation, restart of operation, a previous loading and/or previous removal until at least one article is removed from and/or loaded into the storage facility by the at least one user and/or operation stops is detected, and/or that a time period of at least one user in front of the storage facility without removal from and/or loading of the storage facility is detected, wherein a removal from and/or loading of the storage facility is detected by the load state detection device.

In this context, at least one motion detector, at least one infrared sensor and/or at least one radar module of the user detection device may be evaluated to detect a user.

In particular, the user detection device may scan an area in front of or adjacent to a front side of the storage facility, preferably an area of 180°, in particular in front of or adjacent to a reach-in area for removing articles from and/or loading articles into the storage facility.

In this context, it may also be preferred according to the present disclosure that the user detection device of at least one of the storage facilities is arranged in the upper half, preferably on the front side, of the storage facility, in particular in a cover area, preferably above the reach-in area of the storage facility.

Also, a load state of the storage facility may be determined by means of a load state detection device.

In this context, it may be preferred that measured values representative of a weight of the storage facility are detected by a weighing apparatus, and the measured values are evaluated by an evaluating device at defined times in order to determine the load state of the storage facility, wherein the measured values are evaluated when the measured values of the weighing apparatus are not affected by devices of the storage facility and/or if the evaluating device compensates for effects of the devices of the storage facility, in particular by means of statistical algorithms.

Also, the weight of the storage facility may be detected within a weighing range from 0 kg to 200 kg with a measurement accuracy in a range from one nanogram to one gram, particularly preferred in a range from one nanogram to one microgram.

In this context, the weighing apparatus may comprise at least one load cell, in particular four load cells, wherein each of the load cells comprises at least one strain gauge, preferably four strain gauges, that are arranged in the form of a bridge circuit, preferably a Wheatstone bridge.

Also, the load cells may be arranged below the storage facility, preferably in the area of feet of the storage facility, in particular between the feet of the storage facility and the storage facility and/or underneath the feet of the storage facility.

Also, a load state of the storage facility with articles may be determined based on the weight of the storage facility, wherein, based on a change in weight of the storage facility, it is in particular determined that an article is removed from the storage facility and/or an article is loaded into the storage facility.

Also, according to the present disclosure the time when at least one article, in particular one and/or several beverage cans and/or bottles, is removed from and/or loaded into the storage facility may be stored in a memory, preferably the number of articles that are removed during a removal and/or the number of articles loaded into the storage facility when it is loaded may be stored in the memory.

Also, it is preferred that a data transmission device is provided, in particular for transmitting data via a wire-based or wireless computer network and/or using a mobile communication standard, preferably GSM and/or UMTS, and that in particular the storage facility is in operative connection with a server, wherein data is preferably sent from the storage facility to the server and/or retrieved from the server and/or data is transmitted from the server to the storage facility.

Also, data from the storage facility may be provided to a user on a display device by the server, in particular automatically, in particular the server may automatically send an e-mail, a push message, an SMS, and/or an MMS containing the data of the storage facility.

Also, according to the present disclosure a change of an actual position of the storage facility may be detected by means of a position detection device, and the actual position of the storage facility may preferably be sent to the server.

Also, it is preferred that the actual position of the storage facility is compared with a predefined desired position by the position detection device and/or the server, and that in particular a difference between the actual position and the desired position is displayed to a user on the display device of the storage facility, and/or an e-mail, a push message, an SMS and/or an MMS is sent to the user.

Also, a desired position of the storage facility may be stored in a memory of the storage facility, and preferably the desired position may be defined and/or changed, in particular by means of an input device of the storage facility and/or of the server.

In particular, an operating state of the storage facility may also be detected by means of an operating state detection device of the storage facility, wherein it is preferably detected whether the storage facility is switched on or switched off, maintenance work is taking place or due to take place and/or the facility is malfunctioning or at fault, wherein in particular the operating state of the storage facility is displayed on the storage facility by means of the display device and/or is sent to the server and/or retrieved from the server, in particular in real time, wherein preferably a desired operating state is stored in a memory and preferably the desired operating state is defined and/or changed.

Also, it is preferred that the actual operating state of the storage facility is compared with a predefined desired operating state by the operating state detection device and/or the server, and that in particular a difference between the actual operating state and the desired operating state is displayed on the display device of the storage facility, and/or that an e-mail, a push message, an SMS, and/or an MMS is sent.

Also, according to the present disclosure a temperature of a storage area of the storage facility may be measured, and in particular the temperature that has been measured may be displayed on a display device of the storage facility, and/or the temperature measured may be retrieved from the server and/or sent to the server.

Also, the weight of at least one article, in particular of a plurality of articles, may be stored in a memory as a reference value.

Also, preferred that at least one storage facility parameter is defined for the storage facility, wherein the storage facility parameter is selected so as to be representative of an installation site, a country, a customer group, a dealer, a dealer group, and/or an identification number.

Also, according to the present disclosure it may be possible to transmit data from the user detection device, the temperature measurement device, the operating state detection device and/or the position detection device to the server and/or to retrieve said data from the server at regular intervals, in particular intervals of 30 minutes and/or 60 minutes.

Also, the user detection device may detect at which time and/or on which date a user is detected by the user detection device, and preferably the time and/or the date may be stored, preferably in a memory of a data processing device, in particular a data processing device of the server.

Also, according to the present disclosure the storage facility may be provided in the form of a refrigeration appliance, wherein the refrigeration appliance provides a refrigeration device and preferably an operating time of the refrigeration device is detected and/or stored and is in particular sent to the server and/or retrieved from the server, and preferably the measured values may not be evaluated when a refrigeration device of the refrigeration appliance is operating to effect refrigeration.

Finally, the refrigeration appliance may also be operated using a refrigeration device in the form of a compressor, wherein in particular no data of the weighing apparatus is evaluated by the evaluating device when the compressor is switched on to effect refrigeration of the refrigeration appliance.

The present disclosure is thus based on the surprising finding that a computer network, comprising at least one storage facility having a data processing device and a data transmission device, and at least one server that is in, or can be brought into, operative connection with the at least one storage facility, allows to optimize the detection of a user behavior and to optimize supply chains if at least one of the storage facilities comprises a load state detection device and a user detection device. In this context, it has in particular be found to be advantageous if the user detection device detects a time period of a user in front of the at least one storage facility and the load state detection device detects that at least one article is removed from and/or loaded into the at least one storage facility by the at least one user. In this context, information of the user detection device and/or the load state detection device of the at least one storage facility may be transmitted to the server.

For the purposes of the present disclosure, a computer network means not only a classic computer network comprising at least one computer and preferably at least one server. A computer network according to the present disclosure may also comprise data processing devices and data transmission devices that are, for example, comprised by mobile phones, storage facilities, for example, refrigeration appliances, or the like. For example, an exemplary computer network according to the present disclosure may exclusively comprise devices comprising data processing devices, without comprising a conventional computer. A computer network according to the present disclosure may, for example, preferably comprise devices that can provide and/or retrieve data or exchange, receive and/or send data by means of suitable network devices. For the purposes of the present disclosure, the term “computer network” can also mean a combination of data processing device(s) and data transmission device(s), servers, storage facility/facilities, such as refrigerators, and optionally further devices comprising data processing device(s).

A computer network according to the present disclosure is preferably in operative connection with at least two storage facilities and comprises at least one output device for displaying information or data from the storage facilities.

In this context, the computer network may advantageously store data from the storage facilities after sorting them according to defined parameters, for example, in accordance with a storage facility parameter and/or an actual position of the storage facilities. This has, in particular, the advantage that an overview of the installation sites, i.e., the actual positions, of the storage facilities can easily be displayed to a user with reduced technical effort and minimal use of resources.

In this context, it may in particular be advantageous that the server receives and/or retrieves data from at least one of the storage facilities, in particular automatically, wherein at least one of the storage facilities transmits data relating to at least one storage facility parameter and/or from at least one user detection device, at least one temperature measurement device, at least one operating state detection device, at least one load state detection device and/or at least one position detection device to the server, and that the data is sorted and/or stored in accordance with an installation site, a country, a dealer, a customer group, a dealer group, and/or an identification number and shown, in particular on an output device, by the server.

To detect a behavior of a user by means of the load state device and the user detection device, a time period until at least one article is removed from and/or loaded into the storage facility by the at least one user may be detected. Furthermore, alternatively or additionally a time period of at least one user in front of the storage facility without removal from and/or loading of the storage facility may be detected. The fact that something is removed or loaded is detected by the load state device in each case.

Said user detection device is preferably arranged above a reach-in area of the storage facility and may, for example, comprise a motion detector, a light sensor, an infrared sensor and/or a radar module to detect a user. In this context, a reach-in area can be the area of a storage facility that allows a user to place articles in or remove articles from the storage facility. It may be possible to close the reach-in area, for example, by means of a door. The user detection device thus serves to determine whether and how long a user is or has been in front of a storage facility before removing an article from and/or loading an article into the storage facility and/or whether nothing is removed and/or loaded. In this context, it may be advantageous to store in a memory at which time, in particular on which date and at which time of day, a user removes something from and/or loads something into the storage facility.

It may also be advantageous that data of the user detection device can be sent to the server and/or retrieved from the server.

A user detection device according to the present disclosure thus serves to obtain information relating to a time a user spends in front of the storage facility before deciding to remove and/or load something.

In this context, it may be advantageous that the user detection device is arranged in the upper half, preferably on the front side, of a storage facility. In particular, it may be advantageous that the user detection device is arranged in a cover area. A cover area can, for example, be a covering of the storage facility, that is arranged so as to cover technical equipment above the reach-in area of the storage facility.

A storage facility according to the present disclosure thus allows, for example, to optimize supply chains of articles. In addition to detecting whether and when an article has been removed from the storage facility, it is possible to determine a change in user behavior. This may, for example, be advantageous when new articles, for example, a new beverage, preferably a new beverage in a beverage can, is first introduced to the market. The user detection device according to the present disclosure can detect within which time period, at which time and on which date a user decides to remove the new beverage can. Based on the detection of this data, it can be predicted when the next delivery will have to be made and how many articles are to be delivered.

Furthermore, it may be advantageous that the storage facility has a weighing apparatus to determine the weight of the storage facility. In this context, it may be advantageous that a load state of the storage facility with a plurality of different articles can be determined by precisely determining the weight of the storage facility alone. Furthermore, a precise measurement of the change in weight of the storage facility allows to determine that an article is removed from the storage facility or an article is loaded into a storage facility.

To this end, according to the present disclosure a weighing apparatus may continuously record measured values representative of a weight of the storage facility, and an evaluating device that may preferably be designed in the form of a data processing device, may determine the weight of the storage facility based on the measured values of the weighing apparatus. In this context, it has been found to be advantageous that the weight of the storage facility is not determined when the measured values of the weighing apparatus are affected by devices of the storage facility.

For example, it has been found to be advantageous that the evaluating device of a loading device in the form of a refrigeration appliance does not evaluate data of the weighing apparatus when a refrigeration device of the refrigeration appliance affects the measured values of the measuring device. In this context, only a refrigeration device not including a compressor may be used, for example, an adsorption refrigeration device. If a compressor refrigeration device is used, vibrations of the compressor could affect the measured values of the measuring device during operation. In this context, it has been found to be advantageous that in case of a refrigeration appliance having a compressor refrigeration device the measured values are only evaluated at certain times, for example, when a compressor is not operating, or that the compressor is mechanically separated from the measuring device, so that the compressor is supported in particular in a vibration-free manner relative to the measuring device. In both possible configurations according to the present disclosure, the compressor refrigeration device can thus be prevented from affecting the measured values, and it can thus be precisely determined which articles are removed from and loaded into the storage facility.

According to the present disclosure, a weighing scale, in particular a mechanical, electronic, and/or electromechanical weighing scale, may be comprised by the storage facility as a weighing apparatus, wherein the weighing apparatus measures or detects the weight of the storage facility with a high measurement accuracy. In this context, it may be advantageous that the weighing apparatus has a weighing range from 0 kg to 200 kg with a measurement accuracy in a range from one nanogram to one gram, particularly preferred in a range from one nanogram to one microgram.

Such a precise determination of the weight of the storage facility requires that the measured values of the weighing apparatus are not affected by other devices of the storage facility; in particular, devices of the storage facility that, for example, vibrate must not be active. Such vibrations may distort the measured values of the weighing apparatus. Of course the measured values of the weighing apparatus may also be distorted by other devices of the storage facility, so that the measured values of the weighing apparatus should also not be evaluated by the evaluating device when these devices are operating.

A high measurement accuracy according to the present disclosure may, for example, be achieved by means of a weighing apparatus comprising at least one load cell, preferably four load cells, wherein each of the load cells preferably comprises one strain gauge, preferably four strain gauges, that are arranged in the form of a bridge circuit, preferably a Wheatstone bridge. A bridge circuit in the form of a Wheatstone bridge can, for example, allow to precisely measure the weight of the storage facility if the electric resistances of the Ohmic kind of the strain gauges are evaluated. In this context, each two strain gauges or their resistors form a voltage divider, and two voltage dividers are arranged parallel to each other. A voltmeter relates the voltage dividers to each other, so that the measured parameter of the arrangement is a voltage difference between the voltage dividers, also referred to as diagonal bridge voltage. This Wheatstone bridge has, in particular, the advantage that the resistors of the strain gauges that are sensitive to expansion and whose resistance will increase or decrease depending on the deformation of the resistors, complement each other in the same direction. However, temperature changes or the like do not affect the measurement result as they have the same effect on all strain gauges and neutralize each other.

In this context, it is preferred that the load cells and/or the strain gauges of the load cells are arranged below the storage facility, in particular in the area of feet of the storage facility. In this context, it may be advantageous that the strain gauges are arranged underneath the feet or between the feet and the body of the storage facility.

A load state of the storage facility may thus be determined based on the weight of the storage facility, wherein, based on a change in weight of the storage facility, it can be determined, for example, that an article is removed from the storage facility and/or an article is loaded into the storage facility, wherein it is in particular also possible to determine the type of article and the number of articles.

According to the present disclosure, a load state of the storage facility may also be determined directly from the weight of the storage facility. In this context, the weights of the articles located in the storage facility may more advantageously be stored as reference values in a memory of the storage facility and/or a memory that is in operative connection with the storage facility.

It is also preferred that a change in weight of the storage facility is used to determine the type of article that is removed from and/or placed in the storage facility and the number of articles concerned. In this context, the change in weight can be compared with the weights of the articles stored as reference values. Also, it is preferred that the time when something is removed from and/or loaded into the storage facility is stored in a memory.

For example, according to the present disclosure articles in the form of food items, in particular in the form of beverage cans or bottles, may be stored in a storage facility. When a user, in this exemplary case a consumer, removes, for example, a beverage can from the storage facility, the weight of the storage facility will change due to the removal of the can. In the memory of the storage facility, a reference value for a weight of each type of can located in the storage facility is stored, so that the number and type of cans that have been removed can be determined based on the change in weight of the storage facility caused by the removal. If a precision weighing apparatus is used that is preferably comprised by the storage facility, not only cans differing in volume can be determined but, due to the different specific weight of different beverages, also the type of beverage that has been removed. For example, it can be detected whether a particular beverage in the can removed from the storage facility in the example contains sugar or not as the storage facility according to the present disclosure can even detect such small differences between the specific weights of the beverages and thus of the cans. A crucial factor in such a precise measurement of the weight of the storage facility is the fact that devices of the storage facility do not affect the measured values of the weighing apparatus.

Also, according to the present disclosure the storage facility may comprise a data processing device, in particular a computer, wherein the evaluating device and the data processing device may be designed as one unit. In this context, it may be advantageous that the storage facility comprises a data transmission device in order to transmit data to a further data processing device, for example, a server, a mobile phone or the like. Preferably, data may be transmitted from the storage facility to a further data processing unit via a wire-based or wireless network and/or using a mobile communication standard, in particular the GSM and/or UMTS standard.

In this context, according to the present disclosure the storage facility may also be in operative connection with a server, wherein data can be sent from the storage facility to the server and/or retrieved from the server and vice versa. In this context, it may be advantageous that the server is in operative connection with further terminals and/or another server, in particular that the server makes available information or data from the storage facility to a user, for example, displays said information or data on an output device and/or transmits a message to the user, for example, in the form of an e-mail, an SMS, an MMS, and/or a push message.

Also, the storage facility may comprise an input device that, for example, allows a user to operate the storage facility and/or to provide and/or retrieve data and/or information of the storage facility. In this context, an input device according to the present disclosure may, for example, be provided in the form of a keyboard, a mouse, a touch screen and/or the like.

Furthermore, it may be advantageous that the storage facility has a position detection device to determine an actual position of the storage facility. Such a position detection device according to the present disclosure may, for example, be provided in the form of a GPS receiver and/or a device for network cell tracking. In this context, a desired position of the storage facility may be stored in a memory, and it may be possible at all times to compare the actual position of the storage facility with the desired position, and/or such a comparison of the actual position with the desired position may be made automatically, for example, in real time and/or at regular intervals. The desired position can be predefined at the discretion of a user and changed when required.

In this context, a difference between the actual position and the desired position of the storage facility may be displayed to a user on a display device of the storage facility and/or on a display device that is in operative connection with the server, and/or the storage facility and/or the server may inform a user of said difference by means of an SMS, an MMS, an e-mail, and/or a push message.

Such a position detection device has in particular the advantage that it allows to display where a storage facility is located. If the actual position of the storage facility is found to differ from a desired position of the storage facility, a user can be informed immediately. An operator of a storage facility according to the present disclosure can thus check, for example, whether the storage facility continues to be in the desired position in a shop.

According to the present disclosure, the storage facility may also comprise an operating state detection device. The operating state detection device can detect whether a storage facility is in a switched-on or switched-off state and/or whether the storage facility is malfunctioning. In this context, a desired operating state of a storage facility may be stored in a memory, and the desired operating state may be compared with an actual operating state continuously and/or at intervals. If the actual operating state is found to differ from the desired operating state, the difference can be displayed to a user by means of a display device, for example, a display device of the storage facility and/or a display device that is in operative connection with the server. Of course, a user may also be informed of the difference between the actual operating state and the desired operating state, either additionally or exclusively, by means of an SMS, an MMS, an e-mail, and/or the like. Such an operating state detection device has a number of advantages, some of which will, by way of example only, be explained below.

It can, for example, be defined in a memory at which time of day and on which days a storage facility should be operating. Such predefined operating times of the storage facility may, for example, be contractually agreed with a dealer. The operator of a storage facility can thus check whether a storage facility is operating at the agreed times. Also, maintenance and/or a repair of the storage facility can be made easier as a service centre and/or a service employee can be immediately informed of a malfunction of the storage facility.

Also, a storage facility may comprise at least one temperature measurement device to measure the temperature at least in an area of the storage facility. Advantageously, two or more temperature measurement devices may also be provided to measure a temperature in particular areas of the storage facility. The actual temperatures that have been measured can be compared with desired temperatures stored in a memory, and a user can be informed of differences between the actual temperature and the desired temperature. In this context, the data processing device of the storage facility and/or the server may compare an actual temperature with a desired temperature of the storage facility, and a user may be informed of the difference. It may be advantageous that the difference between the actual temperature and the desired temperature of the storage facility is displayed to a user on a display device, for example, a display device of the storage facility and/or a display device that is in operative connection with the server.

This has, among others, the advantage that the temperature of the articles can be checked, for example, in case of perishable goods and/or articles that tend to taste better when they are cold, in particular beverages. Furthermore, continuous storage of the at least one measured temperature serves to prove that a predefined maximum temperature of the articles located in the storage facility has not been exceeded. This may in particular be advantageous in case of food items.

Also, according to the present disclosure the storage facility may comprise at least one storage facility parameter, in particular representative of an installation site, a country, a customer group, a dealer, a dealer group, and/or an identification number for unambiguous identification of a particular storage facility.

It may also be advantageous that data from the user detection device, the at least one temperature measurement device, the operating state detection device, relating to the storage facility parameter and/or from the position detection device is regularly sent to the server and/or retrieved from the server. In this context, the data may be sent to the server and/or become retrievable from the server at regular intervals, in particular intervals of 30 minutes or 60 minutes.

Also, it may be preferred according to the present disclosure that the storage facility is designed in the form of a refrigeration appliance or refrigerator. In this context, the weight of the storage facility may in particular not be evaluated when a refrigeration device of the refrigerator is operating. Preferably, the refrigeration appliance is designed in the form of a compressor refrigerator, an absorption refrigerator, and/or a thermoelectric refrigerator. In this context, the weight of the refrigerator is in particular not evaluated when a compressor is active.

A refrigeration device, in particular a compressor of a refrigeration device, of a refrigerator causes vibrations that affect a precise measurement of the weight of the storage facility. The weight of the refrigerator can thus only be precisely determined when the refrigeration device is not active or if the measuring device is mechanically decoupled from the vibrations of the compressor. A refrigeration device of a refrigerator normally operates at intervals in order to reduce the temperature within a refrigerated area of the refrigerator when it exceeds a predefined threshold. While the temperature is below the threshold, the refrigeration device is not active or not operating. According to the present disclosure, the weight of the storage facility is of course not determined either when other devices of the storage facility affect the determination of the weight.

If, however, the measuring device is mechanically decoupled from the compressor, measured values can be detected continuously. However, complex technical measures are required to mechanically decouple the measuring device from the compressor in existing refrigeration appliances, whereas it is relatively easy to retrofit existing refrigeration appliances with a measuring device.

Therefore both approaches to improving the measurement accuracy of a measuring device are advantageous.

Also, according to the present disclosure the storage facility may have an open storage area, in particular an open refrigerated area, and in particular no door or the like for closing the storage area.

A storage facility according to the present disclosure thus allows to precisely determine a removal and/or loading as well as a load state of the storage facility, and to determine that articles are located in the storage facility and/or removed from or placed in the storage facility by measuring the weight of the storage facility alone. Furthermore, an operating state, an actual position and/or a temperature of the storage facility can be detected and preferably stored and optionally compared with desired values, and a difference from the desired values can be displayed to a user and/or a user can be informed of said difference. The user detection device according to the present disclosure also serves to evaluate user behavior, so that, for example, market research data can be obtained.

A computer network according to the present disclosure thus allows to centrally monitor a plurality of storage facilities with simple means, wherein a load state of the storage facility, a removal from and/or loading of the storage facility and a user behavior can be detected and evaluated, as well as information relating to the operating state, the temperature, the actual position and/or further information of the storage facilities.

Furthermore, user behavior can be evaluated in detail, so that precise data relating to user behavior can be taken into account, for example, for optimizing a supply chain. It can be detected how user behavior changes in accordance with an installation site, a time and/or a date, and these changes can be taken into account when adapting supply chains, marketing, installation sites and/or the like.

The computer network according to the present disclosure also serves to monitor whether the owner of a shop who has been provided with a storage facility continues to place the storage facility in an agreed position and/or to operate the storage facility at agreed times.

In particular, in this context the computer network according to the present disclosure may centrally detect and process information from a plurality of storage facilities, in particular by means of the server. In this context, information of the storage facilities, can be evaluated, in particular in accordance with a distribution channel of the articles located in the storage facility, for example, petrol stations, supermarkets, railway stations, and the like, a country or defined customers and/or customer groups.

### DESCRIPTION OF THE DRAWINGS

Further features and advantages of the present disclosure will become apparent from the following description, in that exemplary embodiments of the present disclosure are explained with reference to schematic drawings, by way of example and without limiting the present disclosure.

In the figures:

FIG. 1 shows a perspective view of a storage facility according to the present disclosure;

FIG. 2 shows a schematic plan view of a weighing apparatus according to the present disclosure;

FIG. 3 shows a principle view of a storage facility according to the present disclosure;

FIG. 4 shows a principle view of a computer network according to the present disclosure having three storage facilities according to the present disclosure; and

FIG. 5 shows a schematic plan view of a scanning area of a user detection device according to the present disclosure.

### DETAILED DESCRIPTION

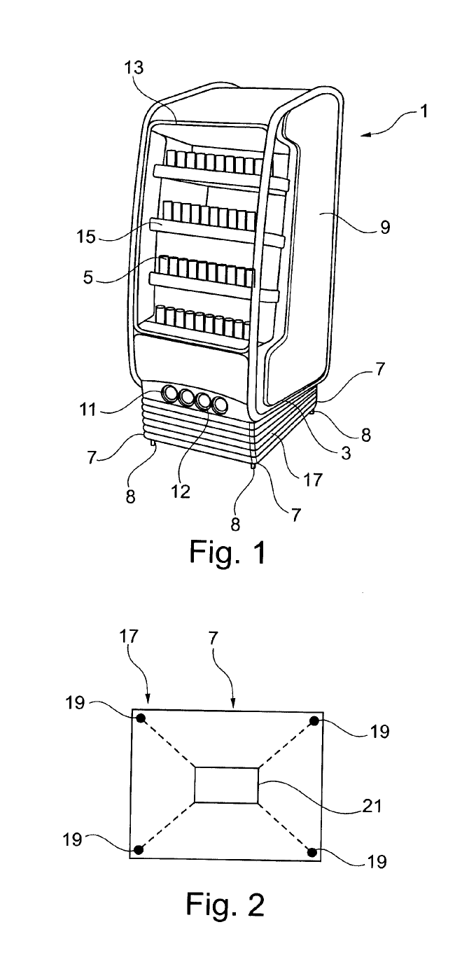

FIG. 1 shows a storage facility 1 in the form of a refrigeration appliance. Said storage facility has a refrigeration device 3 and a refrigerated area 5 as well as a weighing apparatus 7. As shown, the weighing apparatus 7 can comprise four strain gauges that are arranged underneath the feet 8 or between the feet 8 and the storage facility 1.

The weighing apparatus 7 serves to detect the weight of the storage facility 1, that is evaluated by an evaluating device (not shown) at defined times. To be able to determine whether an article, which type of article and how many articles is/are removed from the storage facility 1 or loaded into the storage facility, the measured values of the weighing apparatus are evaluated, wherein the measured values used to determine the weight of the storage facility 1 are not evaluated by the evaluating device (not shown) when the measured values of the weighing apparatus 7 are affected by other devices of the storage facility 1. In particular, the weight of the storage facility 1 is not to be evaluated when the refrigeration device 3 is operating. A refrigeration device 3 normally comprises a compressor (not shown). When the refrigeration device 3 is operating to cool the refrigerated area 5, the compressor will vibrate, thus causing the storage facility 1 to vibrate, so that the measured values of the weighing apparatus 7 are distorted. Alternatively, it is of course possible to provide refrigeration devices that do not need a compressor, such as adsorption refrigeration systems. As another alternative, the refrigeration device 3 may be mechanically decoupled from the weighing apparatus 7, so that vibrations of a compressor of the refrigeration device will not affect the measured values of the weighing apparatus 7. To be able to precisely determine the weight of the storage facility 1, i.e., according to the present disclosure, no measured values of the weighing apparatus 7 are to be evaluated by the evaluating device (not shown) in this exemplary embodiment using a compressor refrigeration device that is not mechanically decoupled when the refrigeration device 3 is operating or another device of the storage facility 1 affects the measured values of the weighing apparatus 7.

Furthermore, the storage facility 1 comprises at least one temperature measurement device 9 and a display device 11. The display device 11 is, by way of example, designed in the form of lighting means 12. Of course, additional or alternative display devices may be provided, for example, a display (not shown).

In an upper area of the storage facility 1, a user detection device 13 is arranged that detects a user in a defined area in front of the storage facility 1. In this context, it can in particular be detected at which time and on which date a user (not shown) spends a particular time period within the user detection device, and whether the user (not shown) removes articles from the storage facility 1 and/or places articles in the storage facility 1 and if so, how many. In this context, it is preferred that the data of the user detection device 13 is stored in a memory (not shown).

Also, the storage facility 1 may have a holding device 15 for articles, in particular a holding device 15 for food items, preferably beverage cans and/or bottles.

According to the present disclosure, it may be advantageous that the storage facility 1 has a bottom area 17 where the refrigeration device 3 and/or further devices of the storage facility 1 is/are arranged, for example, a data processing unit (not shown).

FIG. 2 shows a schematic plan view of the weighing apparatus 7 according to the present disclosure from FIG. 1. Said weighing apparatus 7 comprises 4 load cells 19 that are arranged below a bottom area 17 of the storage facility (not shown in FIG. 2). The weight sensors used can be strain gauges (not shown). Of course, other weight sensors than the strain gauges shown in the figure can also be used. The strain gauges are, by way of example, arranged in the form of a bridge circuit, in particular a Wheatstone bridge, and the measured values of the weighing apparatus 7 or the strain gauges are evaluated by the evaluating device 21 at defined times.

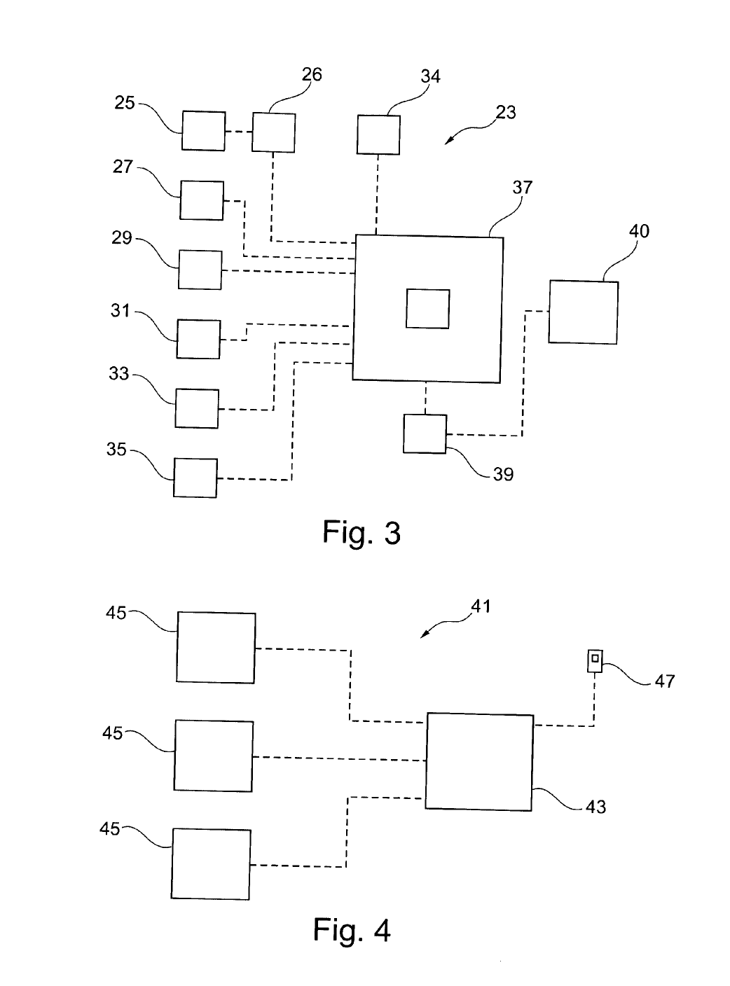

FIG. 3 shows a principle view of a storage facility 23 according to the present disclosure. Said storage facility 23 comprises a weighing apparatus 25, an evaluating device 26 for evaluating measured values of the weighing apparatus 25, a position detection device 27, a display device 29, a user detection device 31, an operating state detection device 33, an input device 34 and a temperature measurement device 35.

In this context, data from the aforesaid devices 25, 26, 27, 31, 33, 34, and 35 may in particular be processed by a data processing device 37, in particular a computer. Also, the data processing device 37 may be in operative connection with a data transmission device 39, and it may be possible to send information or data from the data processing device 39 to a server 40 and/or retrieve said information or data from the server 40.

FIG. 4 shows a computer network 41 according to the present disclosure having three storage facilities 45 according to the present disclosure. Said storage facilities 45 comprise at least one data transmission device, so that data or information from the storage facilities 45 can be sent to a server 43 and/or retrieved from the server 43. In this context, the server 43 may be in operative connection with at least one further terminal 47, for example, a mobile terminal. Such a computer network 41 according to the present disclosure can make it possible that a plurality of information from storage facilities 45 can be displayed to a user with minimal use of resources. In particular, the information can be sorted and displayed in accordance with a particular storage facility 45, an installation site of a storage facility 45 and/or a plurality of further parameters.

A computer network 41 according to the present disclosure thus allows to centrally detect a load state of storage facilities 45 as well as removals from and/or a loading of storage facilities 45 in real time, thus obtaining precise information on user behavior. Furthermore, the information can be used to optimize logistics processes, for example, supply chains and supply times, and detailed consumer data can be obtained.

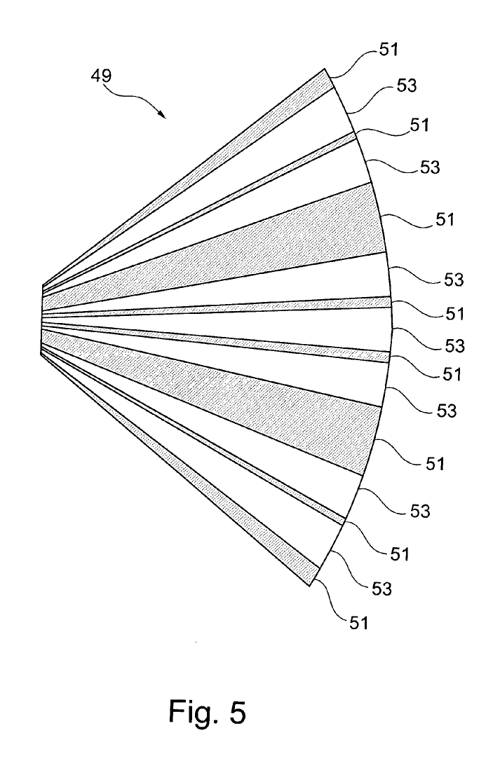

FIG. 5 shows, by way of example, a plan view of a schematic scanning area 49 of a user detection device (not shown) according to the present disclosure. In this context, the storage facility (not shown) may in particular comprise a radar module that does not scan particular areas 51 within a scanning area 49 and only evaluates areas 53.

The features of the present disclosure disclosed in the above description, the claims and the drawings can be essential, both individually and in any combination, to implement the present disclosure in its various embodiments.

### LIST OF REFERENCE NUMERALS

1, 23, 45 Storage facility
3 Refrigeration device
5 Refrigerated area
7, 25 Weighing apparatus
8 Foot
9, 35 Temperature measurement device
11, 29 Display device
12 Lighting means
13, 31 User detection device
15 Holding device
17 Bottom area
19 Load cell
21, 26 Evaluating device
25 Position detection device
33 Operating state detection device
34 Input device
37 Data processing device
39 Data transmission device
40, 43 Server
41 Network
47 Terminal
49 Scanning area
51, 53 Area

1. A computer network, comprising:
at least one storage facility,
at least one data processing device,
at least one data transmission device, and
at least one server in operative connection with the at least one storage facility,
wherein the at least one storage facility comprises:
a user detection device configured to detect a time period of at least one user in front of and/or adjacent to the at least one storage facility, and
a load state detection device configured to detect a removal of at least one article from the at least one storage facility and/or a loading of at least one article into the at least one storage facility by the at least one user,
wherein the data of the user detection device and/or of the load state detection device can be sent to the at least one server and/or can be retrieved from the at least one server.

2. The computer network according to claim 1, wherein the at least one server is in operative connection with at least one input device and/or at least one output device.

3. The computer network according to claim 1, wherein:
the at least one server is configured to automatically retrieve data from the at least one storage facility, and/or the at least one storage facility is designed and configured to automatically send data to the server, preferably at intervals,
the at least the one storage facility is configured to send data relating to at least one storage facility parameter to the at least one server.

4. The computer network according to claim 1, wherein the at least one server is configured to display the data on an output device according to an installation site, a country, a customer group, a dealer, a dealer group, and/or an identification number of the storage facility.

5. The computer network according to claim 1, wherein the user detection device of at least one of the storage facilities is configured to detect a time period from a start of operation, restart of operation, a previous loading of, and/or previous removal from the storage facilities until the next removal and/or loading of at least one article into the storage facility and/or stopping of operation of the storage facility, and/or to detect a time period of at least one user in front of the storage facility without removal from and/or loading of the storage facility, wherein a removal from and/or loading of the storage facility is detectable and/or is detected by the load state detection device.

6. The computer network according to claim 1, wherein the user detection device of at least one of the storage facilities comprises at least one motion detector, at least one infrared sensor, and/or at least one radar module.

7. The computer network according to claim 1, wherein the user detection device of the at least one of the storage facility is configured to scan an area in front of and/or adjacent to a front side of the storage facility in front of a reach-in zone for removing articles from and/or loading articles into the storage facility.

8. The computer network according to claim 7, wherein the user detection device of the at least one of the storage facility is arranged in an upper half of the storage facility above the reach-in zone of the storage facility.

9. The computer network according to claim 1, wherein the data of the user detection device is retrievable from an external server and/or is sendable to the external server in real time.

10. The computer network according to claim 1, further comprising a load state detection device comprising a weighing apparatus configured to detect measured values representative of a weight of the at least one storage facility and an evaluating device configured to determine the weight of the at least one storage facility based on the measured values of the weighing apparatus.

11. The computer network according to claim 10, wherein the weighing apparatus comprises at least one weighing scale.

12. The computer network according to claim 10, wherein the evaluating device is part of a data processing unit.

13. The computer network according to claim 10, wherein the weighing apparatus is configured to detect the weight of the storage facility within a weighing range from 0 kg to 200 kg with a measurement accuracy in a range from one nanogram to one gram.

14. The computer network according to claim 10, wherein the weighing apparatus comprises at least one load cell.

15. The computer network according to claim 10, wherein the at least one load cell is arranged below the storage facility.

16. The computer network according to claim 10, a load state of the at least one storage facility with articles is determined based on the weight of the storage facility, and wherein the at least one storage facility is configured to determine a change in the load state based on a change in weight of the at least one storage facility.

17. The computer network according to claim 10, further comprising at least one memory configured to store the time when at least one article is removed from and/or loaded into the at least one storage facility and/or to store the number of articles that are removed during a removal and/or the number of articles inserted during loading of the storage facility.

18. The computer network according to claim 1, wherein the at least one storage facility is configured to store at least one article in the form of a food item.

19. The computer network according to claim 1, wherein the at least one storage facility comprises a computer and/or a memory.

20. The computer network according to claim 1, wherein the at least one of the storage facility comprises a data transmission device configured to transmit data via a wire-based or wireless computer network and/or using a mobile communication standard.

21. The computer network according to claim 1, wherein the at least one server is in operative connection with at least one further facility.

22. The computer network according to claim 1, wherein the at least one server is configured to automatically display and/or provide data from the at least one of the storage facility on a display device.

23. The computer network according to claim 1, wherein the at least one storage facility comprises an input device, the storage facility comprises a device configured to receive data from an external server, and/or the storage facility comprises a display screen.

24. The computer network according to claim 1, wherein the at least one storage facility comprises a position detection device.

25. The computer network according to claim 24, wherein the position detection device is configured to detect a change of an actual position of the at least one storage facility and to transmit the actual position of the at least one storage facility to the at least one server.

26. The computer network according to claim 24, wherein the position detection device is configured to compare the actual position of the at least one storage facility with a predefined desired position.

27. The computer network according to claim 26, wherein the desired position of the at least one storage facility is stored in a memory of the at least one storage facility and wherein the desired position can be defined and/or changed by a user.

28. The computer network according to claim 1, wherein the at least one storage facility comprises an operating state detection device configured to detect an operating state of the at least one storage facility.

29. The computer network according to claim 28, further comprising a display device configured to display the operating state of the at least one storage facility.

30. The computer network according to claim 28, wherein a desired operating state is stored in a memory, and the desired operating state can be defined and/or changed by a user.

31. The computer network according to claim 28, wherein the data processing device of the at least one storage facility is designed and configured to compare the operating state with a predefined desired operating state, and display a difference between the operating state and the desired operating state can on a display device of the at least one storage facility.

32. The computer network according to claim 31, wherein the at least one storage facility is configured to transmit the difference between the actual operating state and the desired operating state to the at least one server.

33. The computer network according to claim 1, wherein the at least one storage facility comprises a temperature measurement device configured to detect the temperature at least in an area of the storage facility, wherein the at least one storage facility comprises at least two temperature measurement devices, wherein a first temperature measurement device is configured to detect a first temperature in a first area of the at least one storage facility and a second temperature measurement device is configured to detect a second temperature in a second area of the at least one storage facility.

34. The computer network according to claim 33, wherein the at least one storage facility is configured to display at least one of the first and second temperatures and/or send the at least one of the first and second temperatures to the at least one server.

35. The computer network according to claim 1, wherein reference values of the weight of at least one article of a plurality of products, are stored in at least one memory of at least one of the storage facility.

36. The computer network according to claim 1, wherein the at least one storage facility comprises at least one storage facility parameter representative of an installation site, a country, a customer group, a dealer, a dealer group, and/or an identification number.

37. The computer network according to claim 1, wherein data relating at least to the at least one storage facility parameter and/or data from the at least one user detection device, at least one temperature measurement device, at least one operating state detection device, and/or at least one position detection device can be sent to the at least one server, retrieved from the at least one server, displayed, and/or stored in accordance with a day, a time of day, a week, a year, an installation site, a customer, a country, or a town/city.

38. The computer network according to claim 1, wherein the user detection device of at least one of the storage facilities is configured to detect at time at which and/or a date on which a user is detected by the user detection device.

39. The computer network according to claim 38, wherein the at least one storage facility is designed in the form of a refrigeration appliance comprising a refrigeration device wherein an operating time detection device is configured to detect an operating time of the refrigeration device, wherein the weight of the refrigeration appliance is determined when a refrigeration device of the refrigeration appliance is not operating, and/or is mechanically decoupled from the weighing apparatus.

40. The computer network according to claim 39, wherein the refrigeration appliance is designed in the form of a compressor refrigerator, an absorption refrigerator, and/or a thermoelectric refrigerator.

41. The computer network according to claim 39, wherein the refrigeration appliance comprises at least one refrigeration device in the form of a compressor, wherein the computer network comprises a filter configured to filter out data of the weighing apparatus detected and/or evaluated by the evaluating device when the compressor is active.

42. The computer network according to claim 38, wherein the at least one storage facility comprises a holding device for food items.

43. The computer network according to claim 1, wherein the at least one storage facility has an open storage area that lacks door for closing the refrigerated area.

44. The computer network according to claim 43, wherein the at least one storage facility comprises a temperature measurement device configured to detect the temperature at least in the open storage area of the storage facility.

45. A method for operating a computer network, in particular, a computer network according to claim 1, comprising at least one storage facility, at least one data processing device, at least one data transmission device, wherein preferably the data processing device and the data transmission device are arranged in the storage facility, and at least one server in operative connection with the at least one storage facility, the method comprising:
detecting, by a user detection device of the at least one storage facility, a time period of at least one user in front of the at least one storage facility is detected by the user detection device,
detecting, by a load state detection device of the at least one storage facility, removal of at least one article from and/or loading of at least one article into the at least one storage facility by the at least one user, and
sending data of the user detection device and/or the load state detection device of the at least one storage facility to the server.

46. The method according to claim 45, wherein the at least one server is in operative connection with at least one input device and/or at least one output device.

47. The method according to claim 45, further comprising automatically sending data of at least one storage facility parameter from the at least one storage facility to the at least one server.

48. The method according to claim 45, further comprising storing, by the at least one server, the data in accordance with an installation site, a country, a customer group, a dealer, a dealer group, and/or an identification number of the storage facility.

49. The method according to claim 45, further comprising:
detecting a time period from a start of operation, restart of operation, a previous loading, and/or a previous removal until removal of at least one article from and/or loading of at least one article into the storage facility by the at least one user and/or stopping of operation of the storage facility by the at least one user, and/or a time period of at least one user in front of the storage facility without removal from and/or loading of the storage facility is detected, wherein a removal from and/or loading of the storage facility is detected by the load state detection device.

50. The method according to claim 45, further comprising evaluating at least one motion detector, at least one infrared sensor, and/or at least one radar module of the user detection device to detect a user.

51. The method according to claim 45, further comprising scanning, by the user detection device, an area in front of or adjacent to a front side of the storage facility in front of or adjacent to a reach-in zone for removing articles from and/or loading articles into the storage facility.

52. The method according to claim 51, wherein the user detection device of at least one of the storage facilities is arranged in an upper half, preferably on the front side in a cover area above the reach-in zone of the storage facility.

53. The method according to claim 45, further comprising determining, by the load state detection device, a load state of the storage facility.

54. The method according to claim 53, further comprising:
detecting, by a weighing apparatus, measured values representative of a weight of the at least one storage facility, and
evaluating, by an evaluating device, the measured values at defined times in order to determine the load state of the storage facility, wherein evaluating the measured values comprises evaluating the measured values of the weighing apparatus that are not affected by devices of the at least one storage facility.

55. The method according to claim 54, wherein the weight of the at least one storage facility is detected within a weighing range from 0 kg to 200 kg with a measurement accuracy in a range from one nanogram to one gram.

56. The method according to claim 45, wherein the weighing apparatus comprises at least one load cell, wherein each of the at least one load cells comprises at least one strain gauge.

57. The method according to claim 56, wherein the at least one load cell is arranged below the storage facility.

58. The method according to claim 54, further comprising determining a load state of the storage facility with articles based on the weight of the at least one storage facility and determining, based on a change in weight of the storage facility, that an article has been removed from and/or loaded into the at least one storage facility.

59. The method according to claim 45, further comprising determining a time of a removal of at least one article from and/or loading of at least one article into the at least one storage facility.

60. The method according to claim 45, further comprising transmitting the data via a wire-based or wireless computer network from the at least one storage facility to the at least one server.

61. The method according to claim 45, further comprising automatically displaying the data from the at least one storage facility on a display device by the at least one server.

62. The method according to claim 45, further comprising detecting a change of an actual position of the at least one storage facility by a position detection device.

63. The method according to claim 62, further comprising comparing, by the position detection device, the actual position of the at least one storage facility is compared with a predefined desired position.

64. The method according to claim 62, wherein a desired position of the storage facility is stored in a memory of the storage facility.

65. The method according to claim 45, further comprising detecting an operating state of the storage facility by an operating state detection device of the at least one storage facility.

66. The method according to claim 65, further comprising comparing, by the operating state detection device, the operating state of the storage facility with a predefined desired operating state.

67. The method according to claim 45, further comprising measuring a temperature of a storage area of the at least one storage facility.

68. The method according to claim 45, storing, in a memory, a weight of at least one article as a reference value.

69. The method according to claim 45, further comprising defining at least one storage facility parameter for the at least one storage facility, wherein the at least one storage facility parameter is selected so as to be representative of an installation site, a country, a customer group, a dealer, a dealer group, and/or an identification number.

70. The method according to claim 45, transmitting data from at least one of the user detection device, a temperature measurement device, an operating state detection device and/or a position detection device to the at least one server at intervals.

71. The method according to claim 45, further comprising detecting, by the user detection device, a time at which and/or a date on which a user is detected by the user detection device.

72. The method according to claim 45, wherein the storage facility is provided in the form of a refrigeration appliance comprising a refrigeration device, the method further comprising detecting an operating time of the refrigeration device.

73. The method according to claim 72, wherein the refrigeration device is in the form of a compressor, the method further comprising evaluating, by an evaluating device, weighing data that does not include the effects of the compressor on a weighing apparatus.

74. The computer network according to claim 1, wherein the at least one data processing device and the at least one data transmission device are arranged in the at least one storage facility.

75. The computer network according to claim 16, wherein based on the change in weight of the at least one storage facility, a removal of an article from the storage facility and/or a loading of an article into the storage facility is determined.

76. The computer network according to claim 37, wherein the data relating at least to the at least one storage facility parameter and/or the data from the at least one user detection device, at least one temperature measurement device, at least one operating state detection device, and/or at least one position detection device can be sent to the at least one server, retrieved from the at least one server, displayed, and/or stored continuously or at regular intervals, wherein the regular intervals are at intervals of 30 minutes and/or 60 minutes.
